(19) United States
(12) Patent Application Publication
(10) Pub. No.: US 2010/0208386 A1
(43) Pub. Date: Aug. 19, 2010

(54) PERPENDICULAR MAGNETIC RECORDING MEDIUM WITH ANTI-FERROMAGNETICALLY COUPLED MAGNETIC LAYERS AND MAGNETIC STORAGE APPARATUS

(75) Inventor: Georg Lauhoff, Fremont, CA (US)

Correspondence Address: IRELL & MANELLA LLP, 1800 AVENUE OF THE STARS, SUITE 900, LOS ANGELES, CA, 90067, US

(73) Assignee: Samsung Electronics Co., Ltd., Suwon City (KR)

(21) Appl. No.: 12/372,635

(22) Filed: Feb. 17, 2009

(51) Int. Cl. G11B 5/52; G11B 5/62; B05D 5/12

(52) U.S. Cl. 360/86; 428/848; 427/131

(57) ABSTRACT

A disk for a hard disk drive. The disk includes a recording layer that is supported by a substrate and a stabilization layer that is anti-ferromagnetically coupled to the recording layer. Because the recording and stabilization layers are anti-ferromagnetically coupled the net magnetization is the difference in magnetization of the two layers. The stabilization layer has a Curie temperature that is lower than a Curie temperature of the recording layer. As temperature increases the magnetization properties of the stabilization layer will have a greater change than the same properties of the recording layer. The net magnetization, coercively and nucleation field of the recording and stabilization layers can be designed to vary less with increasing temperature than disk of the prior art.

### BACKGROUND OF THE INVENTION

1. Field of the Invention

The subject matter disclosed generally relates to disk media of hard disk drives.

2. Background Information

Hard disk drives contain a plurality of heads that are magnetically coupled to rotating disks. The heads write and read information by magnetizing and sensing the magnetic fields of the disk surfaces.

There are generally two different types of magnetic heads, horizontal recording heads and perpendicular magnetic recording heads (“PMR heads”). Horizontal recording heads magnetize the disk in a direction that is essentially parallel with the outer surface of the disk. PMR heads magnetize the disk in a direction essentially perpendicular to the outer surface of the disk. PMR heads are preferred because perpendicular recording allows for higher bit densities and corresponding increases in the data capacity of the drive.

The disks typically include layers of various materials including a ferro-magnetic recording layer. Certain properties of magnetic materials vary with temperature.

For example, the magnetic moment, coercively and nucleation field decrease with increasing temperature. At low temperatures the heads may not generate a sufficient magnetic field strength to properly magnetize the recorded bit of the disk resulting in an increase in bit errors. At relatively high temperatures the magnetic field may create undesired adjacent track errors during the writing process.

### BRIEF SUMMARY OF THE INVENTION

A disk for a hard disk drive. The disk includes a recording layer that is supported by a substrate and a stabilization layer that is anti-ferromagnetically coupled to the recording layer. The stabilization layer has a Curie temperature that is different than the Curie temperature of the recording layer.

### BRIEF DESCRIPTION OF THE DRAWINGS

FIG. 1 is a top view of a hard disk drive;

FIG. 2 is an illustration of a disk of the hard disk drive; and,

FIG. 3 is an illustration showing the net magnetization of a recording layer and a stabilization layer of a disk at different temperatures.

### DETAILED DESCRIPTION

Disclosed is a disk for a hard disk drive. The disk includes a recording layer that is supported by a substrate and a stabilization layer that is anti-ferromagnetically coupled to the recording layer. Because the recording and stabilization layers are anti-ferromagnetically coupled the net magnetization is the difference in magnetization of the two layers. The stabilization layer has a Curie temperature that is lower than the Curie temperature of the recording layer. As temperature increases the magnetization properties of the stabilization layer will have a greater change than the same properties of the recording layer. The net magnetization and also other magnetic properties such as the coercively and nucleation field of the recording and stabilization layers can be engineered to vary less with increasing temperature than disk of the prior art.

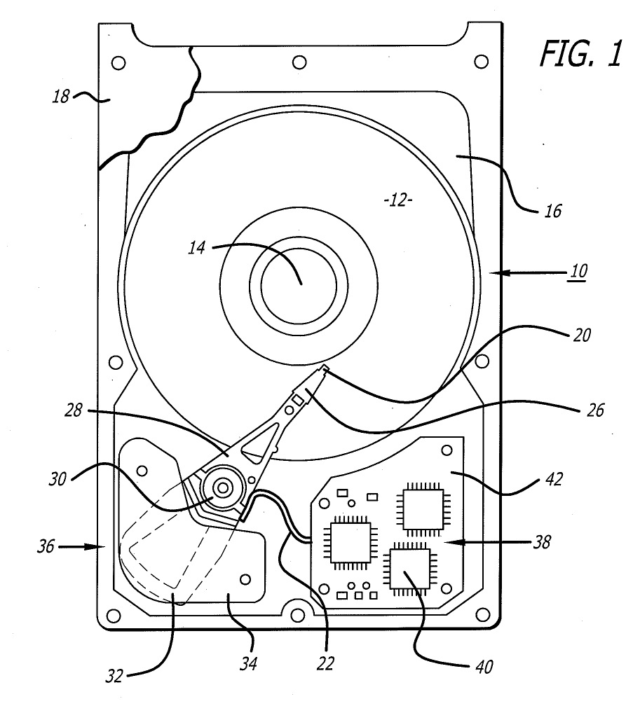

Referring to the drawings more particularly by reference numbers, FIG. 1 shows an embodiment of a hard disk drive 10. The disk drive 10 may include one or more magnetic disks 12 that are rotated by a spindle motor 14. The spindle motor 14 may be mounted to a base plate 16. The disk drive 10 may further have a cover 18 that encloses the disks 12.

The disk drive 10 may include a plurality of heads 20 located adjacent to the disks 12. The heads 20 may have separate write and read elements (not shown) that magnetize and sense the magnetic fields of the disks 12.

Each head 20 may be gimbal mounted to a flexure arm 22 as part of a head gimbal assembly (HGA).

The flexure arms 22 are attached to an actuator arm 24 that is pivotally mounted to the base plate 16 by a bearing assembly 26. A voice coil 28 is attached to the actuator arm 24. The voice coil 28 is coupled to a magnet assembly 30 to create a voice coil motor (VCM) 32. Providing a current to the voice coil 28 will create a torque that swings the actuator arm 24 and moves the heads 20 across the disks 12.

Each head 20 has an air bearing surface (not shown) that cooperates with an air flow created by the rotating disks 12 to generate an air bearing. The air bearing separates the head 20 from the disk surface to minimize contact and wear.

The hard disk drive 10 may include a printed circuit board assembly 34 that includes a plurality of integrated circuits 36 coupled to a printed circuit board 38. The printed circuit board 38 is coupled to the voice coil 28, heads 20 and spindle motor 14 by wires (not shown).

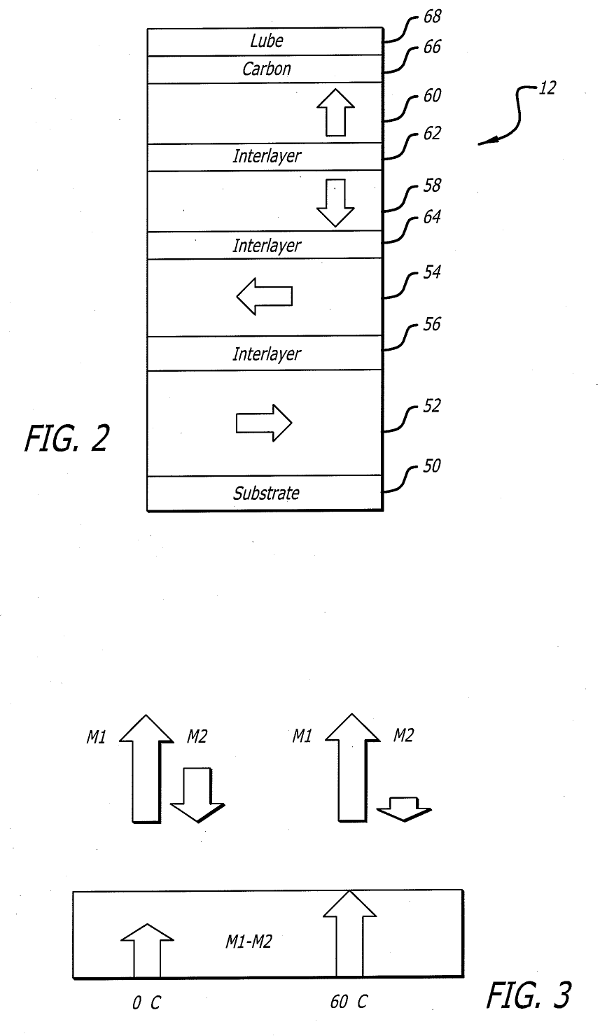

FIG. 2 shows an embodiment of the disk 12. The disk 12 includes a substrate 50 that supports a first layer of magnetic material 52 and a second layer of magnetic material 54 separated by an intermediate layer 56.

The disk 12 includes a stabilization layer 58 that is anti-ferromagnetically coupled to a recording layer 60.

The stabilization and recording layers may be separated by an intermediate layer 62. Likewise, the stabilization layer 58 may be separated from the second layer of magnetic material 54 by intermediate layer 64.

The stabilization layer 58 has a Curie temperature that is lower than a Curie temperature of the recording layer 60. The Curie temperature is the temperature at which a material changes from ferromagnetic to paramagnetic. By way of example, the recording layer may have a composition of (CoCrPtB) and the stabilization layer 58 may include CoCrPt—SiO₂ or CoCrPt—TiO₂. The intermediate layer may include ruthenium. The layer thicknesses, compositions and magnetizations may be selected to minimize disk errors in a typical disk drive operating temperature range, which can be between 0 to 60° C.

FIG. 3 shows the relative magnetizations of the recording layer M1 and the stabilization layer M2 at different temperatures. Because the layers are anti-ferromagnetically coupled together, the net magnetization is the difference between M1 and M2. Because of the lower Curie temperature the stabilization layer has a greater change in magnetization with increasing temperature than the recording layer. The result is a change in net magnetization, with increasing temperature, that is lower than a change in magnetization of prior art disks. Furthermore the change in the coercively, which is typically DHc/dT=−15 Oe and the nucleation field (typically ˜dHn/dT=−20 Oe) can be designed to show a smaller reduction with temperature or may be even designed to increase with temperature by choosing materials for the recording layer and stabilization layer with a appropriate properties such as the Curie temperature, coercively, nucleation field. The composition, thickness, etc. of the layers can be varied to obtain a desired smaller decrease change in net magnetization, coercively and nucleation field or even an increase in magnetization, coercively and nucleation with increasing temperature.

Referring to FIG. 2, the disk may also have a protective diamond-like-carbon layer 66 and a lubricant layer 68.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A magnetic disk for a hard disk drive, comprising:
a substrate;
a recording layer that is supported by said substrate, said recording layer having a Curie temperature; and,
a stabilization layer that is anti-ferromagnetically coupled to said recording layer, said stabilization layer having a Curie temperature that is different than said Curie temperature of said recording layer.

2. The disk of claim 1, wherein said stabilization layer Curie temperature is lower than said recording layer Curie temperature.

3. The disk of claim 1, further comprising an intermediate layer located between said recording layer and said stabilization layer.

4. The disk of claim 1, further comprising at least one magnetic layer located between said recording layer and said substrate.

5. A hard disk drive, comprising:
a base plate;
a spindle motor coupled to said base plate;
a disk coupled to said spindle motor, said disk including;
a substrate;
a recording layer that is supported by said substrate, said recording layer having a Curie temperature;
a stabilization layer that is anti-ferromagnetically coupled to said recording layer, said stabilization layer having a Curie temperature that is different than said Curie temperature of said recording layer;
an actuator arm mounted to said base plate;
a voice coil motor coupled to said actuator arm; and,
a head coupled to said actuator arm and said disk.

6. The hard disk drive of claim 5, wherein said stabilization layer Curie temperature is lower than said recording layer Curie temperature.

7. The hard disk drive of claim 5, further comprising an intermediate layer located between said recording layer and said stabilization layer.

8. The hard disk drive of claim 6, further comprising at least one magnetic layer located between said recording layer and said substrate.

9. The hard disk drive of claim 6, wherein said disk is perpendicularly recorded.

10. A method for fabricating a disk of a hard disk drive, comprising:
forming a stabilization layer over a substrate, the stabilization layer having a Curie temperature; and,
forming a recording layer over the stabilization layer, the recording layer being anti-ferromagnetically coupled to the stabilization layer and having a Curie temperature different than the stabilization layer Curie temperature.

11. The method of claim 10, wherein the stabilization layer Curie temperature is lower than the recording layer Curie temperature.

12. The method of claim 10, further comprising forming an intermediate layer between the recording layer and the stabilization layer.

13. The method of claim 10, further comprising forming at least one magnetic layer between the recording layer and the substrate.
